(19) United States
(12) Patent Application Publication
(10) Pub. No.: US 2019/0243031 A1
(43) Pub. Date: Aug. 8, 2019

(54) Lens with Protective Contact Surfaces

(71) Applicant: Bobby Gene Burrough, San Jose, CA (US)

(72) Inventor: Bobby Gene Burrough, San Jose, CA (US)

(21) Appl. No.: 15/888,779

(22) Filed: Feb. 5, 2018

(51) Int. Cl. G02B 1/14

(52) U.S. Cl. CPC G02B 1/14

(57) ABSTRACT

Lens with protective contact surface. In an exemplary embodiment, an apparatus is provided that includes a lens having an external surface and a protective contact surface protruding from the external surface.

### FIELD

The present invention relates to the field of lenses. More specifically, the present invention relates to the design of lenses to prevent damage.

### BACKGROUND

Lenses, such as optical lenses, are a mature and prevalent technology. The first lenses were fashioned thousands of years ago. Over the last 250 years, lenses have become prevalent in the form of eyeglasses, cameras, telescopes, binoculars, and many other products. Today, various lenses are installed in virtually all handheld devices and smartphones carried by billions of people. This means that the lens installed on these devices must withstand the punishment of day-to-day use, harsh work environments, travel, sports activity, and other demanding environments. For example, devices may be dropped or mishandled, packed in luggage or briefcases, or routinely placed in contact with hard surfaces. Thus, the portability of these devices has subjected the lenses they carry to continual abuse and potential for damage.

Therefore, it would be desirable to provide an effective mechanism for protecting lenses from damage due to the use or misuse of the devices in which the lenses are installed.

### SUMMARY

In various exemplary embodiments, a lens with a protective contact surface is disclosed. The protective contact surface protects the lens by protruding slightly above the surface of the lens. If an object or surface is about the contact the lens, the protective contact surface will be the first part of the lens to come into contact with the object or surface. Thus, the protective contact surface sustains any damage from the impact while the remainder of the lens remains undamaged. In one embodiment, the lens and the protective contact surface are formed as a single piece. In another embodiment, the protective contact surface is formed on a stud that is fitted into the lens and protrudes above the surface of the lens. In this embodiment, the lens and the stud are separate pieces that may be of the same or different material. In an exemplary embodiment, the stud is attached to the lens so that the stud and the protective contact surface protrude slightly above the surface of the lens. In another exemplary embodiment, the stud is attached to the lens so that the stud and the protective contact surface do not protrude above the surface of the lens.

In an exemplary embodiment, a smartphone device is equipped with a lens having a protective contact surface for use with a camera system installed on the device. The lens has a small protrusion that extends from the surface of the lens that includes a protective contact surface. As such, when the smartphone is placed on a table or other hard surface and slides around, the protective contact surface contacts the hard surface first, such that the optically important areas of the lens are not scratched or damaged. Rather, the protective contact surface sustains any damage that may occur.

In an exemplary embodiment, an apparatus is disclosed that includes a lens having an external surface. The lens includes a protective contact surface protruding from the external surface.

In an exemplary embodiment, an apparatus is disclosed that includes a lens having an external surface. The apparatus also includes a stud attached to the lens and protruding from the external surface. The stud includes a protective contact surface.

In an exemplary embodiment, an apparatus is disclosed that includes a lens having an external surface, and means for protecting the lens protruding from the external surface.

In an exemplary embodiment, a portable device is disclosed having an image sensor. The device includes a lens covering the image sensor. The lens has an external surface exposed to an environment outside the device. The lens also includes a protective contact surface protruding from the external surface. The protective contact surface is formed as part of the lens or is attached to the lens.

Additional features and benefits of the exemplary embodiments of the present invention will become apparent from the detailed description, figures and claims set forth below.

### BRIEF DESCRIPTION OF THE DRAWINGS

The exemplary embodiments of the present invention will be understood more fully from the detailed description given below and from the accompanying drawings of various embodiments of the invention, which should not be taken to limit the invention to the specific embodiments, but are for explanation and understanding only.

FIG. 1 shows devices comprising exemplary embodiments of lenses having protective contact surfaces;

FIG. 2 shows a device that includes an exemplary embodiment of a lens having a protective contact surface;

FIG. 3 shows exemplary embodiments of two lenses having exemplary embodiments of protective contact surfaces;

FIG. 4 shows three views of an exemplary embodiment of a lens and a protective contact surface that are formed as a single unit from one piece of material;

FIG. 5 shows an exemplary embodiment of a lens having a stud with a protective contact surface where the lens and the stud are separate pieces that comprise the same or different materials;

FIG. 6 shows a handheld device that includes an exemplary embodiment of a lens having a protective contact surface; and

FIG. 7 shows exemplary embodiments of lenses having exemplary protective contact surfaces.

### DETAILED DESCRIPTION

The purpose of the following detailed description is to provide an understanding of one or more embodiments of the present invention. Those of ordinary skill in the art will realize that the following detailed description is illustrative only and is not intended to be in any way limiting. Other embodiments will readily suggest themselves to such skilled persons having the benefit of this disclosure and/or description.

In the interest of clarity, not all of the routine features of the implementations described herein are shown and described. It will, of course, be understood that in the development of any such actual implementation, numerous implementation-specific decisions may be made in order to achieve the developer's specific goals, such as compliance with application and business-related constraints, and that these specific goals will vary from one implementation to another and from one developer to another. Moreover, it will be understood that such a development effort might be complex and time-consuming, but would nevertheless be a routine undertaking of engineering for those of ordinary skill in the art having the benefit of the embodiments of this disclosure.

Various exemplary embodiments illustrated in the drawings may not be drawn to scale. Rather, the dimensions of the various features may be expanded or reduced for clarity. In addition, some of the drawings may be simplified for clarity. Thus, the drawings may not depict all of the components of a given apparatus (e.g., device) or method. The same reference indicators will be used throughout the drawings and the following detailed description to refer to the same or like parts.

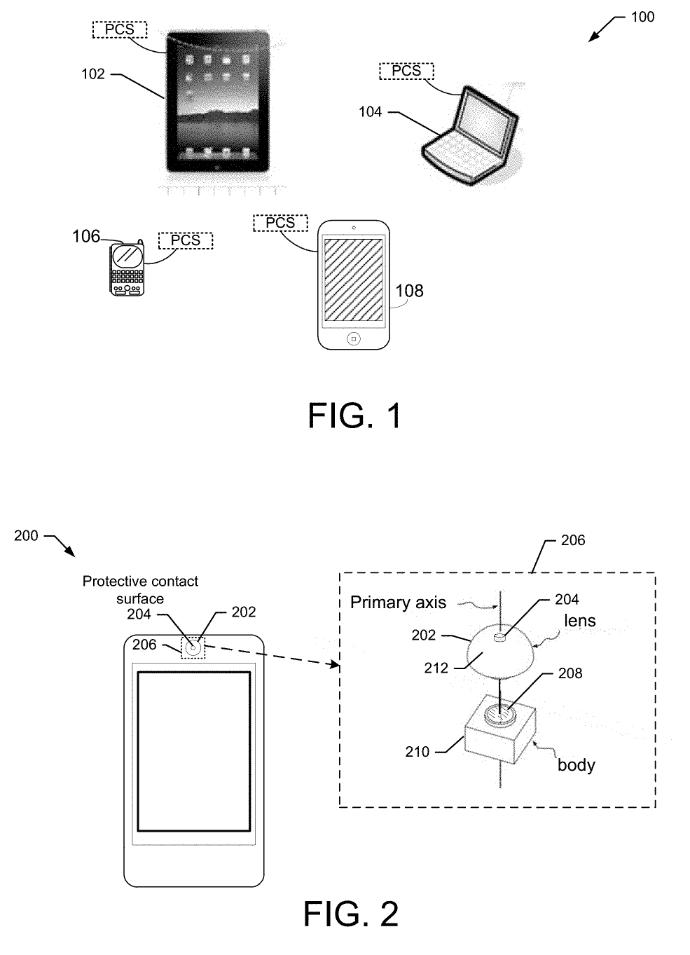

FIG. 1 shows devices 100 comprising exemplary embodiments of lenses having protective contact surfaces (PCSs). The devices shown include tablet computer 102, notebook computer 104, cell phone 106, and smart phone 108. It should be noted that embodiments of lenses having PCSs are suitable for use in virtually any type of device to protect the lenses from damage during the use or misuse of the device.

FIG. 2 shows a device 200 that includes an exemplary embodiment of a lens 202 having a PCS 204. In this embodiment, the lens 202 is part of an image sensor assembly installed in the device 200 to acquire images of the surrounding environment. In various exemplary embodiments, the lens is made of glass, plastic, or any other suitable material and provides any desired level of dioptric power.

In an exemplary embodiment, the PCS 204 protrudes above the external surface of the lens 202. The PCS 204 is positioned on the lens such that, when the device 200 is placed on a surface, the PCS 204 contacts or touches the surface while the optically functional areas of the lens 202 do not. Thus, if the device 200 is placed on a surface in such a way that the lens 202 may be damaged (e.g., cracked or scratched), the PCS 204 will receive the scratches or damage while the remainder of the lens 202 is not damaged.

In an exemplary embodiment, the region 206 is enlarged to show a detailed exemplary embodiment of a sensor body 210 that houses an image sensor 208 that is covered by the lens 202. In this particular embodiment, the lens 202 operates to provide a wide field of view of the surrounding environment that is captured by the image sensor 208. In various exemplary embodiments, the image sensor 208 comprises a high resolution (HD) camera sensor, video camera sensor, color or black and white camera sensor, or other type of image sensor.

The PCS 204 is shown protruding from an external surface 212 of the lens 202 and aligned with the primary axis of the lens/sensor assembly. The external surface 212 of the lens 202 is the surface that is exposed to the environment. For example, when the lens 202 is mounted on the device 200, the external surface 212 is exposed to the environment external to the device. Thus, the external surface 212 of the lens 202 is the surface that is susceptible to damage from user or misuse of the device 200. In various exemplary embodiments, the PCS 204 provides the lens 202 with increased robustness over conventional lenses since the PCS 204 sustains damage from use or misuse of the device 200 while the lens 202 remains substantially operational. In conventional systems, a typical lens would be scratched or cracked as a result of device use or misuse and thereby rendered largely unusable for its intended purpose. However, by augmenting the lens 202 with the PCS 204, the lens 202 remains largely usable for the purpose of image acquisition, while the PCS 204 sustains any damage resulting from the use/misuse of the device 200. In various exemplary embodiments, any image distortions caused by the PCS 204 can be reduced or remedied by image processing techniques performed on the acquired image.

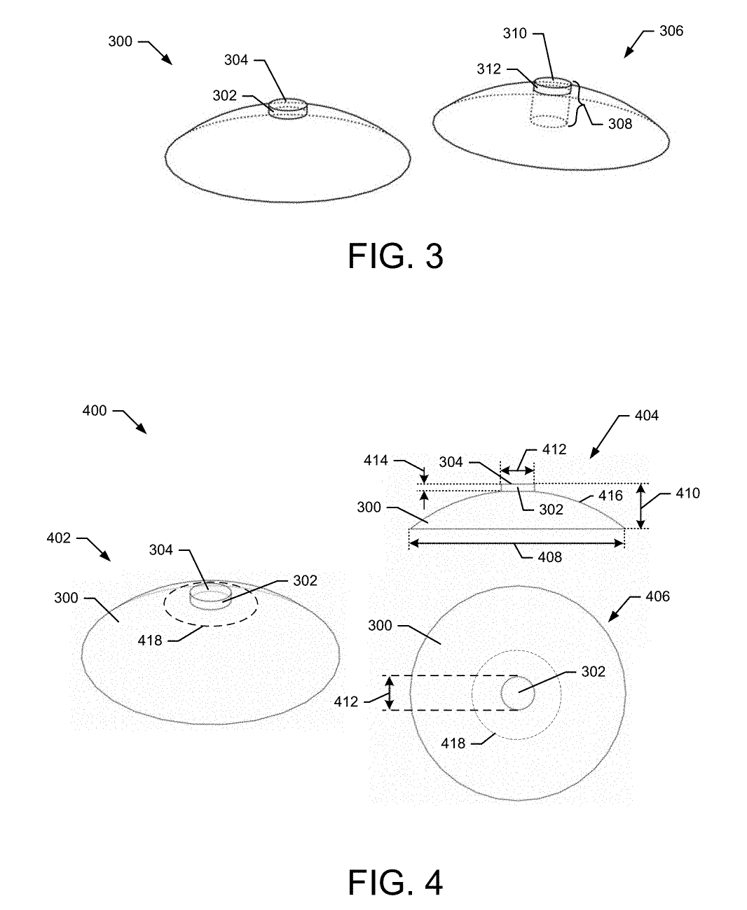

FIG. 3 shows exemplary embodiments of two lenses having exemplary embodiments of protective contact surfaces. In various exemplary embodiments, the lenses are made of glass, plastic, or any other suitable material and provide any desired level of dioptric power. In various exemplary embodiments, the lenses pass light in at least one of visible, infrared, ultraviolet, microwave, or x-ray spectrums. The lenses also comprise external surfaces that have any desire radius of curvature. In one embodiment, the external surfaces of the lenses are flat with no radius of curvature. A first lens 300 includes a protrusion 302 that has an embodiment of a PCS 304. In this embodiment, the protrusion 302 and contact surface 304 made from the same material as the rest of the lens 300, thereby creating a single part. For example, the lens 300, protrusion 302, and PCS 304 are cast or molded as a single unit. In one embodiment, the height of the protrusion 302 above the surface of the lens 302 can be set based on the hardness of the material, the intended lifespan of the lens 300, and the operating environment in which the lens 300 will be used. In various exemplary embodiments, the PCS 304 can have any desired surface texture and/or radius of curvature including no radius of curvature. Softer materials or harsher environments require taller protrusion heights in order to maintain or increase the functional lifespan of the PCS 304. In an exemplary embodiment, the protective contact surface 304 is one of transparent, translucent, or opaque. When the lens 300 is used on a device, any object or surface about to contact the lens 300 will contact the PCS 304 first, thereby protecting the operational part of the lens 300. Thus, the use or misuse of the device may result in damage to the PCS 304, but the surface of the lens 300 will remain usable for image acquisition.

In an exemplary embodiment, a second lens 306 includes an embodiment of a stud 308 that is mounted to the lens 306 to form a protruding region 312 above the surface of the lens 306. The stud 306 also has a PCS 310. In various exemplary embodiments, the PCS 310 can have any desired surface texture and/or radius of curvature including no radius of curvature. In one embodiment, the lens 306 and stud 308 are assembled from two or more parts, which may be made of the same or different materials. In an exemplary embodiment, the stud 308 is one of transparent, translucent, or opaque. When a device is equipped with the lens 306 and stud 308 assembly, any object or surface about to contact the lens 306 will contact the PCS 310 first, thereby protecting the operational part of the lens 306. Thus, the use or misuse of the device may result in damage to the PCS 310 of the stud 308, but the surface of the lens 306 will remain usable for image acquisition.

FIG. 4 shows three views 400 of an exemplary embodiment of the lens 300 as illustrated in FIG. 3. In an exemplary embodiment, the lens 300 and the protective contact surface 304 are formed from one piece of material.

A perspective view 402, shows the lens 300, the PCS 304, and the protrusion 302 of the PCS 304 above the surface of the lens 300. In an exemplary embodiment, the PCS 304 is located within a contact region 418 of the lens 300. The contact region 418 is a region of the lens 300 that is most likely to be contacted by other objects or surfaces. For example, the lens 300 may be installed in a device and the contact region 418 is the region of the lens that is most likely to be contacted and therefore most susceptible to damage from device use or misuse. It should be noted that the location of the contact region 418 depends on how the lens 300 is installed in a device. For example, the contact region 418 may be located in the center of the lens or may be located at any other location on the lens depending upon the susceptibility of the lens in its current installation. In an exemplary embodiment, the PCS 302 is located within the contact region 418.

In a side view 404, the lens 300 and the PCS 304 are shown along with various dimensions. For example, the lens 300 has diameter 408. The protrusion 302 has a height 414 and diameter 412. The height 414 is the height that the PCS 302 protrudes above the external lens surface 416. An overall height 410 includes the height of the lens 300 and the protrusion height 414. The height of the lens 300 can be determined by subtracting the protrusion height 414 from the overall height 410. A top view 406, shows the lens 300 and the PCS 302, which has a diameter 412.

In an exemplary embodiment, the diameter 408 of the lens is 4 millimeters (mm). The curvature of the lens surface 416 is described by a sphere with radius 32 mm. The height of the lens is 1 mm, representing a 1 mm deep subsection of the surface of the sphere that forms the external surface 416 of the lens 300. The protrusion 304 has a height 414 of 0.125 mm that protrudes above the lens surface 416. The PCS 304 is described by a circular area having a diameter 412 of 0.25 mm. It should be noted that the above dimensions are exemplary and that other lens and PCS dimension can be utilized within the scope of the embodiments.

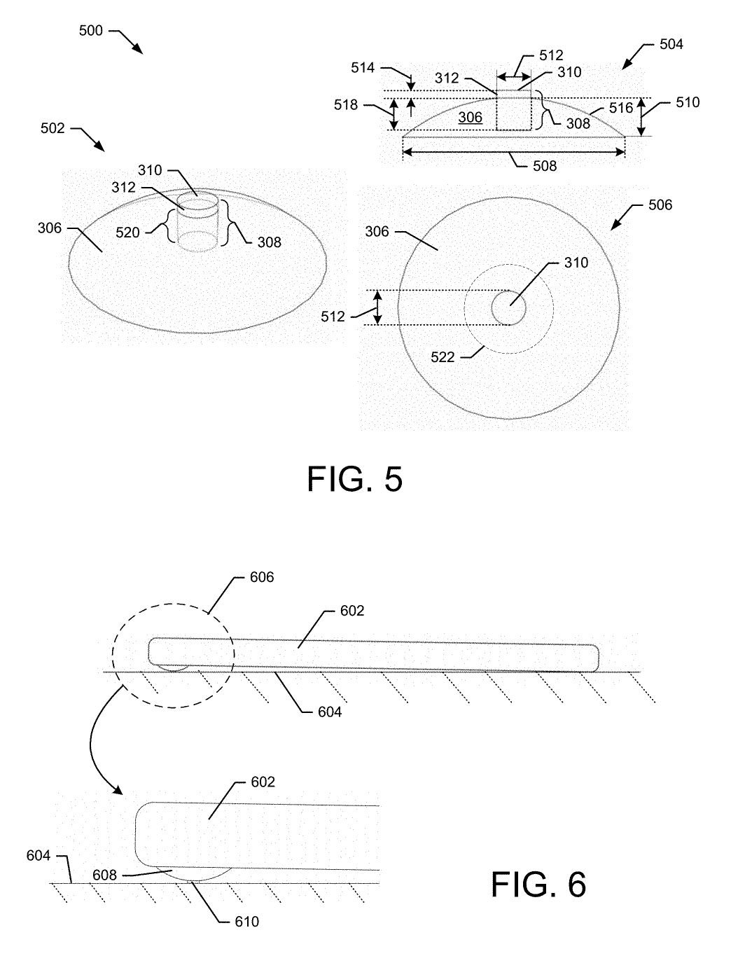

FIG. 5 shows three views 500 of an exemplary embodiment of the lens 306, stud 308, and PCS 310 illustrated in FIG. 3. A perspective view 502, shows the lens 306, stud 308 and PCS 310. In an exemplary embodiment, the lens 306 and the stud 308 are separate pieces of material. In exemplary embodiment, the stud 308 comprises at least one material selected from a set comprising metal, plastic, glass, ceramic, epoxy resin, self-hardening polymer, catalyzed polymer, elastomer, rubber, wood, or any other type of material.

In an exemplary embodiment, the lens 306 is constructed with an opening 520 (or hole) in an external surface of the lens 306 at the appropriate location. The stud 308 is inserted into the opening 520 and attached. For example, in one embodiment, the stud 308 is press-fit into the opening 520, and in another embodiment, the stud 308 is threaded and screwed into the opening 520. In exemplary embodiments, the stud 308 is attached to the lens 306 using at least one attachment mechanism selected from a set comprising press-fit, glue, rivet, snap-in, heat-sealed, screw-threads, or any other attachment means. When the stud 308 is inserted into the opening 520, a protrusion 312 of the stud 308 above the surface of the lens 306 is formed. The PCS 310 is formed on a top portion of the stud 308.

A top view 506, shows the lens 306 and the PCS 310 that is locate on a top portion of the stud 308. In this embodiment, the PCS 310 has a diameter 512. In an exemplary embodiment, the PCS 310 is located within a contact region 522 of the lens 306. The contact region 522 is a region of the lens 306 that is defined to be most susceptible to contact and damage from other objects. For example, the lens 306 may be installed in a device and the contact region 522 is the region of the lens that is most susceptible to contact and damage due to use or misuse of the device. It should be noted that the location of the contact region 522 depends on how the lens 306 is installed in a device. For example, the contact region 522 may be located in the center of the lens or may be located at any other location on the lens depending upon the susceptibility of the lens in its current installation.

In a side view 504, the lens 306 and the stud 308 are shown along with various dimensions. For example, the lens 306 has diameter 508. The PCS 310 at the top portion of the stud 308 has a diameter 512 and the stud 308 has a protrusion height 514 above the surface 516 of the lens. In another exemplary embodiment, the protrusion height 514 can be set to zero such that the protective contact surface 310 aligns with the external surface 516 of the lens 306 to form a smooth surface. In this embodiment, the curvature of the protective contact surface 310 matches the curvature of the external surface 516. For example, in an exemplary embodiment, a section of the lens 306 is replaced with the stud 308 having a protective contact surface having the same geometry as the lens 308 and that constitutes a protective contact surface that is inclusive of the lens surface. The overall height of the stud 308 includes the protrusion height 514 and the depth 518 of the opening 520. The lens 304 also has a height 510.

In an exemplary embodiment, the diameter 508 of the lens is 4 millimeters (mm). The curvature of the lens surface 516 is described by a sphere with radius 32 mm. The height 510 of the lens is 1 mm, representing a 1 mm deep subsection of the surface of the sphere that forms the external surface 516 of the lens 304. The stud 308 has a height 514 of 0.125 mm that protrudes above the lens surface 516. The PCS 310 is described by a circular area with a diameter 512 of 0.25 mm. The depth 518 of the opening 520 is 0.25 mm. It should be noted that the above dimensions are exemplary and that other lens and lens contact point dimensions can be utilized within the scope of the embodiments.

In an exemplary embodiment, the lens 300 is fashioned from optical glass. The lens is ground in such a way as to remove an extra layer of material surrounding the PCS 304, thereby leaving a region of material which serves as the protrusion 302. In consideration of the hardness of the glass and user scenarios of a typical consumer, the height of the protrusion 302 above the lens surface 416 is on the order of several thousandths of an inch (or eighths of a millimeter).

In another exemplary embodiment, the lens 306 is fashioned from optical glass. An opening or hole 520 is drilled in the lens at the appropriate location. A second piece referred to as the stud 308 comprising stainless steel material and is inserted into the opening. In an exemplary embodiment, the stud is held in place with an adhesive. The inserted stud forms a protrusion 312 above the surface 516 of the lens and has a top portion that forms the PCS 310. In consideration of the hardness of stainless steel and user scenarios of a typical consumer, the height of the protrusion of the stud above the lens surface is on the order of several thousandths of an inch (or eighths of a millimeter).

In still another exemplary embodiment, the lens 306 is fashioned from optical glass. An opening or hole 520 is drilled in the lens and is tapped or machined to provide threads along the interior surface of the opening. A second piece referred to as the stud 308 comprises aluminum and is threaded to screw into the tapped opening. The inserted stud forms a protrusion 312 above the surface 516 of the lens and a top portion of the stud forms the PCS 310. In consideration of the hardness of aluminum and user scenarios of a typical consumer, the height of the protrusion of the stud above the lens surface is on the order of several thousandths of an inch (or eighths of a millimeter).

In an exemplary embodiment, the stud 308 comprises an opaque, translucent, or transparent material. That is, a stud blocks all, some, or none of the light that would otherwise pass through it. The opaque stud blocks light that might interfere with properly focused light, which would decrease the quality of the image received by the image sensor. In another embodiment, the stud 308 is shaped such that light does not reflect off the side walls of the lens opening 520, and therefore does not adversely affect the quality of the received image. For example, the stud may be fashioned as a cone, such that the base of the cone is oriented towards the subject, and the sides of the cone recede away from the path of incoming light rays. In an exemplary embodiment, the stud has a three-dimensional shape selected from a set of shapes comprising cylinder, cone, spherical, and rectangular three-dimensional shapes.

In an exemplary embodiment, the PCS (either PCS 304 or PCS 310) is fashioned in one of many different shapes. For example, in an exemplary embodiment, the PCS forms a circular area having a rounded edge that resists chipping. In another exemplary embodiment, the PCS forms a ring geometry that occludes less light entering the lens, and judiciously utilizes the material forming the protrusion for its ability to protect the lens. In another exemplary embodiment, the PCS forms a multi-point star shape to provide for a contact point that incurs major damage (e.g., loss of the entire point of a star), but still retains its ability to protect the optically functional areas of the lens from damage. In exemplary embodiments, the PCS forms a surface selected from a set of surfaces comprising round, square, ring, dome, point, triangular, multipoint star, and N-sided polygon surfaces.

In an exemplary embodiment, a lens is fashioned from optical glass. The lens is ground in such a way as to form three separate protrusions from an external surface of the lens. In an exemplary embodiment, the three protrusions are distributed evenly around the primary axis of the lens, and are each at an equal distance radially from lens center (incident with the primary axis of the lens). At a top portion of each protrusion, a PCS is provided having a selected shape. In another embodiment, two or more protrusions each having a PCS are spaced at any desired spacing within the contact region (e.g., contact region 522). It should be noted that a lens may have any number of protrusions and corresponding PCS s to protect the lens from damage during device use or misuse.

FIG. 6 shows a handheld device 602 that includes an exemplary embodiment of a lens 608 having a PCS 610. In an exemplary embodiment, the handheld device 602 (e.g., smartphone) is placed face down on a flat surface 604. The region 606 is enlarged to further illustrate the relationship between the surface 604, the lens 608, and the device 602. When the device 602 is placed face down on the surface 604 the PCS 610 contacts the surface to protect the optical regions of the lens 608.

As shown in the illustration, the PCS 610 is located at a top portion of a protrusion that extends from the surface of the lens. Insofar as the lens 608 may receive damage or wear from the placement of the device 602 on the surface 604, the PCS 610 will receive the damage instead of the optically important areas of the lens 608.

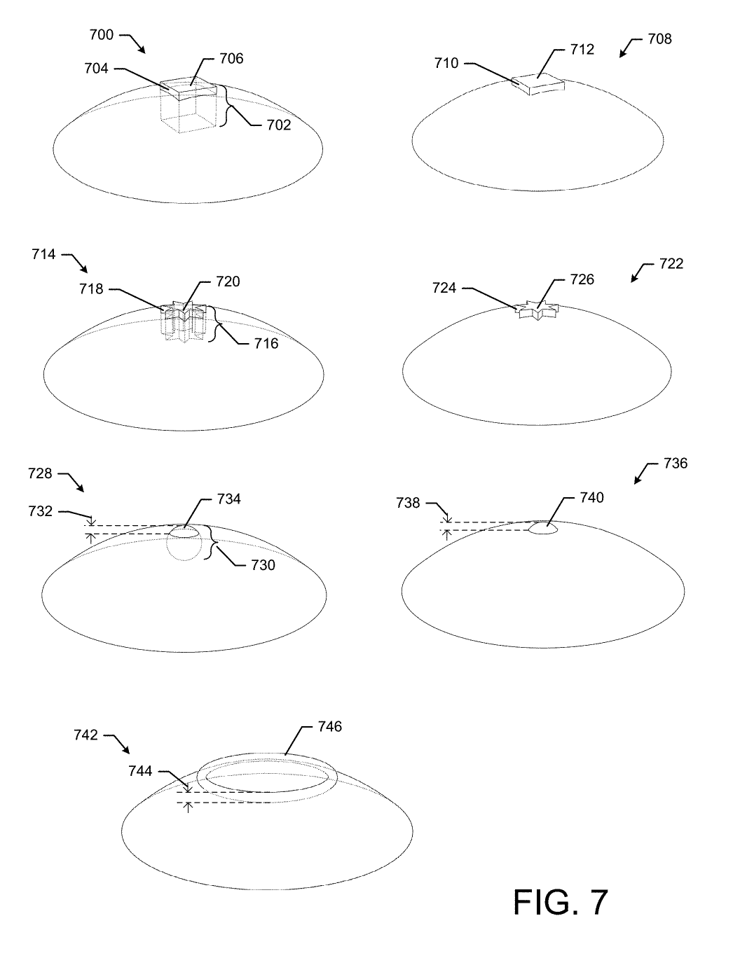

FIG. 7 shows exemplary embodiments of lenses having protective contact surfaces. The lens 700 comprises a stud 702 that is fitted into an opening in the lens such that the stud 702 provides a protrusion 704 above the surface of the lens. On top of the protrusion is the PCS 706. In this exemplary embodiment, the stud 702 is formed as a rectangular cuboid shape and the PCS 706 has a rectangular shape. The lens 708 comprises a single piece where a protrusion 710 is formed on the surface of the lens. The protrusion 710 has a rectangular cuboid shape and a PCS 712 on the top portion of the protrusion has a rectangular shape. Thus, the lenses 700 and 708 illustrate two different lens configurations to obtain PCSs having the same shape.

The lens 714 comprises a stud 716 that is fitted into an opening in the lens such that the stud 716 provides a protrusion 718 above the surface of the lens. On top of the protrusion is the PCS 720. In this exemplary embodiment, the stud 716 is formed as a three-dimensional star shape and the PCS 720 has a star shape. The lens 722 comprises a single piece where a protrusion 724 is formed on the surface of the lens. The protrusion 724 has a three-dimensional star shape and the PCS 726 on the top portion of the protrusion has a star shape. Thus, the lenses 714 and 722 illustrate two different lens configurations to obtain PCSs having the same shape.

The lens 728 comprises a stud 730 that is fitted into an opening in the lens such that the stud 730 provides a protrusion 732 above the surface of the lens. On a top portion of the protrusion is the PCS 734. In this exemplary embodiment, the stud 730 is formed as a sphere and the PCS 734 has a dome shape. The lens 736 comprises a single piece where a protrusion 738 is formed on the surface of the lens. The protrusion 738 has a spherical shape and the PCS 726 on the top portion of the protrusion has a dome shape. Thus, the lenses 728 and 736 illustrate two different lens configurations to obtain PCS s having the same shape.

In still another exemplary embodiment, the lens 742 comprises a single piece where a protrusion 744 is formed on the surface of the lens. The protrusion 744 has a three-dimensional ring (or donut) shape and the PCS 746 on the top portion of the protrusion has a dome shape.

Thus, the lenses shown in FIG. 7 illustrate a variety of studs and PCS shapes within the exemplary embodiments. It should be noted other stud and PCS shapes are also possible. In various exemplary embodiments, an apparatus is provided that comprises a lens, such as any of the lenses shown in FIG. 7. The lens has an external surface and means for protecting the lens that protrudes from the external surface. For example, the means includes at least any of the studs and PCS shapes shown in FIG. 7.

While particular embodiments of the present invention have been shown and described, it will be obvious to those skilled in the art that, based upon the teachings herein, changes and modifications may be made without departing from these exemplary embodiments of the present invention and its broader aspects. Therefore, the appended claims are intended to encompass within their scope all such changes and modifications as are within the true spirit and scope of these exemplary embodiments of the present invention.

What is claimed is:

1. An apparatus, comprising:
a lens having an external surface; and
a protective contact surface protruding from the external surface.

2. The apparatus of claim 1, wherein the lens and the protective contact surface are formed together as a single piece.

3. The apparatus of claim 2, wherein the protective contact surface comprises a shape that is selected from a set of shapes comprising round, square, ring, dome, point, triangular, multipoint star, and N-sided polygon shapes.

4. The apparatus of claim 2, wherein the protective contact surface is one of transparent, translucent, or opaque.

5. The apparatus of claim 1, further comprising a stud having a three-dimensional shape, and wherein the protective contact surface is formed on a top portion of the stud.

6. The apparatus of claim 5, wherein the top portion of the stud protrudes from the surface of the lens.

7. The apparatus of claim 5, wherein the lens and the stud are formed as two separate pieces that are attached together.

8. The apparatus of claim 5, wherein the lens and the stud comprise identical material.

9. The apparatus of claim 5, wherein the lens and the stud comprise different material.

10. The apparatus of claim 5, wherein the stud is one of transparent, translucent, or opaque.

11. The apparatus of claim 5, wherein the stud comprises at least one material selected from a set comprising metal, plastic, glass, ceramic, epoxy resin, self-hardening polymer, catalyzed polymer, elastomer, rubber, and wood materials.

12. The apparatus of claim 5, wherein the stud is attached to the lens using at least one of press-fit, glue, rivet, snap-in, heat-sealed, or screw-threads attachments.

13. The apparatus of claim 5, wherein the stud comprises a three-dimensional shape selected from a set of shapes comprising cylinder, cone, dome, spherical, star, and cuboid three-dimensional shapes.

14. The apparatus of claim 5, wherein the protective contact surface comprises a shape that is selected from a set of shapes comprising round, square, ring, dome, point, triangular, multipoint star, and N-sided polygon shapes.

15. The apparatus of claim 1, wherein the lens passes light in at least one of visible, infrared, ultraviolet, microwave, or x-ray spectrums.

16. The apparatus of claim 1, wherein the protective contact surface protrudes from the external surface within a contact region that is aligned with a center of the lens.

17. The apparatus of claim 1, further comprising one or more additional protective contact surfaces protruding from the external surface.

18. An apparatus, comprising:
a lens having an external surface; and
means for protecting the lens that protrudes from the external surface.

19. The apparatus of claim 19, wherein the means for protecting the lens is formed as part of the lens or is attached to the lens.

20. A portable device having an image sensor, the device comprising:
a lens covering the image sensor and having an external surface exposed to an environment outside the device; and
a protective contact surface protruding from the external surface, and wherein the protective contact surface is formed as part of the lens or is attached to the lens.
